(19) United States
(12) Patent Application Publication
(10) Pub. No.: US 2026/0149254 A1
(43) Pub. Date: May 28, 2026

(54) DEAD END CLAMP

(71) Applicant: SICAME INDIA CONNECTORS PVT LTD, Kanchipuram (IN)

(72) Inventors: Joe VARGHESE JOHN, Kanchipuram (IN); Jyothis BALAKRISHNAN, Kanchipuram (IN); Arun VIJAYAN, Kanchipuram (IN)

(73) Assignee: SICAME INDIA CONNECTORS PVT LTD, Kanchipuram (IN)

(21) Appl. No.: 18/957,183

(22) Filed: Nov. 22, 2024

(51) Int. Cl. H02G 7/05

(52) U.S. Cl. CPC H02G 7/056

(57) ABSTRACT

A dead end clamp for the fixation of a cable. The dead end clamp includes a body with two grooves, an anchoring hook fixed to the body, for each groove, a jaw with a channel to receive the cable, a through-hole crossing at least one jaw and opening in the channel and in front of the body, a sharp pin, a spring and a ball. The sharp pin is fixed at one opening of the through-hole and emerges in the channel, the ball is at the other opening of the through-hole, and the spring is between the sharp pin and the ball. The length of the spring is sufficient to ensure that the spring is in contact with the sharp pin and the ball and that the ball is in contact with the body.

### FIELD OF THE INVENTION

The invention relates to a dead end clamp for anchoring a cable to a pole and for ensuring an equal potential between the cable and the dead end clamp.

### BACKGROUND TO THE INVENTION

A conventional dead end clamp is fixed to a support like a pole to fix an electrical cable to the support. A conventional dead end clamp comprises a metallic body and two jaws that slide in the body to grip the cable. The jaws form a wedge that is blocked in the body.

To ensure good holding of the cable and the dead end clamp, this latter comprises plastic jaws fixed to the metallic body and through which the cable is gripped. The inside surface of the plastic jaws comprises metallic teeth that penetrate in the cable to be in contact with the conductor of the cable. In order to achieve equal potential between the metallic body and the conductor, a secondary piercing connector is used.

Even if such conventional dead end clamp has good results, it can take time to realize these two operations and it is necessary to find a dead end clamp which is easier to install.

### SUMMARY OF THE INVENTION

An object of the present invention is to propose a dead end clamp wherein sharp pins are integrated into the jaws to create the electrical contact between the conductor and the body. Then, when the cable is set between the jaws and the jaws are translated in the body, the tightening of the jaws in the body causes the sharp pins to penetrate in the cable to make the contact with the conductor. Such dead end clamp is then easier to install.

To this end, there is proposed a dead end clamp for the fixation of a cable, said dead end clamp comprising:
a body made of an electrically conductive material and comprising between a first end and a second end, two grooves facing each other and wherein a distance between bottoms of the grooves decreases between the first end and the second end,
an anchoring hook made of an electrically conductive material and fixed to the body,
for each groove, a jaw made of an electrically insulating material and mobile in translation in said groove from the first end toward the second end, each jaw comprising a channel adapted to receive the cable,
for at least one jaw, a through-hole crossing said jaw, wherein a first opening of the through-hole opens in the channel and wherein a second opening of the through-hole faces the body, and
for each through-hole, a sharp pin, a spring and a ball,

wherein the sharp pin, the spring and the ball are made of an electrically conductive material, wherein the sharp pin is fixed at the first opening of the through-hole so that a sharp end of the sharp pin emerges in the corresponding channel, wherein the ball is arranged at the second opening of the through-hole, wherein the spring is arranged between the sharp pin and the ball, and wherein the length of the spring is sufficient to ensure that the spring is in contact with the sharp pin and the ball and that the ball is in contact with the body.

With such the sharp pin penetrates in the cable at the same time, the jaws are set in position.

Advantageously, a diameter of the through-hole at the second opening is smaller than a diameter of the ball.

Advantageously, for each jaw, the dead end clamp comprises blocking means arranged to block the translation of said jaw.

Advantageously, each jaw comprises a proximal end and a distal end, wherein the proximal end is introduced in the corresponding groove and wherein each jaw comprises at its distal end, fastening means arranged to cooperate with the fastening means of the other jaw to attach the two distal ends together.

Advantageously, one of the fastening means are elastic clips fixed to the corresponding jaw and wherein the other fastening means are a slot realized in the corresponding jaw and arranged to receive said elastic clips.

Advantageously, each channel comprises teeth arranged on a surface of the channel.

### BRIEF DESCRIPTION OF THE DRAWINGS

The features of the invention mentioned above, along with others, will become more clearly apparent upon reading the following description of an exemplary embodiment, the description being given with reference to the appended drawings, in which:

FIG. 1 is a perspective view of a dead end clamp according to the invention, and

FIG. 2 is a cross section of the dead end clamp of FIG. 1 cut by the plane II of FIG. 1.

### DETAILED DESCRIPTION OF THE PREFERRED EMBODIMENTS

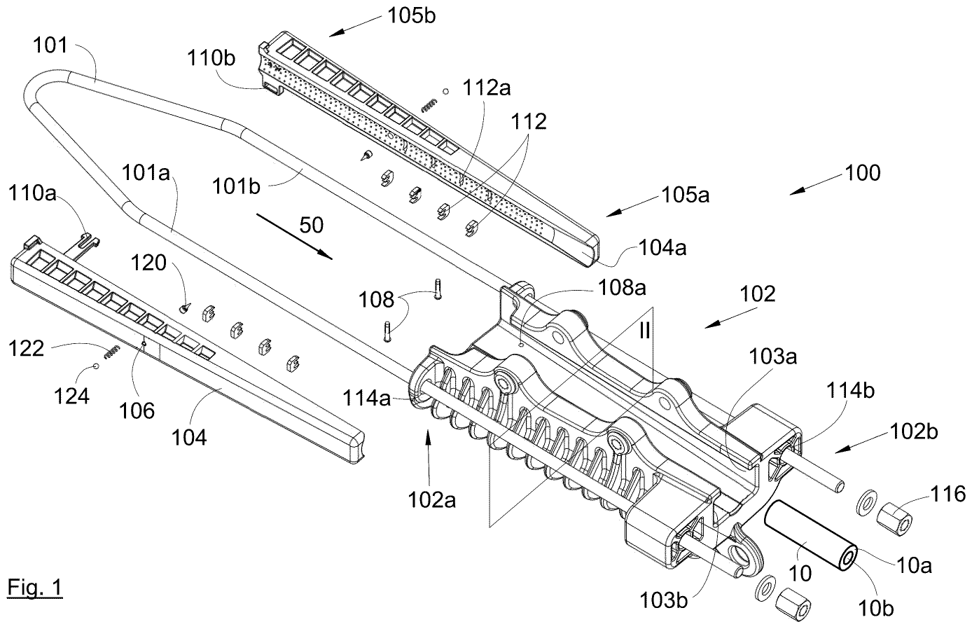

FIG. 1 shows a dead end clamp 100 according to the invention. The dead end clamp 100 is used to fix a cable 10 for example to a pole. The cable 10 is an electrical cable and comprises an insulating sheath 10a and a conductor 10b surrounded by the insulating sheath 10a.

The dead end clamp 100 comprises a body 102 made of an electrically conductive material for example metal. The body 102 extends between a first end 102a and a second end 102b opposite of the first end 102a.

Between the first end 102a and the second end 102b, the body 102 comprises two grooves 103a-b. The grooves 103a-b are facing each other, i.e. the opening of each groove 103a-b is facing the opening of other groove 103a-b.

The distance between the bottoms of the grooves 103a-b decreases between the first end 102a and the second end 102b of the body 102. It means that the width between the grooves 103a-b is larger at the first end 102a that at the second end 102b.

The dead end clamp 100 comprises also a anchoring hook 101 made of an electrically conductive material, for example metal, and it is fixed to the body 102. The anchoring hook 101 is used to fix the dead end clamp 100 to the pole.

Here, the anchoring hook 101 is a rigid metallic wire with two branches 101a-b. The free end of each branch 101a-b is fixed to the body 102. Here, each branch 101a-b goes through two guiding holes 114a-b of the body 102 and at each free end a nut 116 is screwed on the free end to fix the branch 101a-b and the anchoring hook 101.

The anchoring hook 101 and the body 102 are in contact and at an equal electrical potential.

For each groove 103a-b, the dead end clamp 100 comprises a jaw 104 made of an electrically insulating material. Each jaw 104 is mobile in translation in the corresponding groove 103a-b from the first end 102a toward the second end 102b of the body 102.

Each jaw 104 comprises an open channel 104a in which the cable 10 is received. The two channels 104a are facing each other and the cable 10 is set between them.

Due to the decreasing of the bottom distance, when the jaws 104 with the cable therebetween, are translated from the first end 102a toward the second end 102b of the body 102, the jaws 104 tighten and compress and grip the cable 10. The arrow 50 shows the direction of the displacement of the jaws 104 in the body 102.

Each jaw 104 comprises a proximal end 105a and a distal end 105b, where the proximal end 105a is firstly introduced in the corresponding groove 103a-b. When the jaws 104 with the cable 10 are in position, the distal end 105b can stay outside of the body 102 on the side of the first end 102a of the body 102.

Here, each jaw 104 takes the form of a wedge where the thickness of the proximal end 105a is smaller than the thickness of the distal end 105b to compensate the decreasing of the bottom distance.

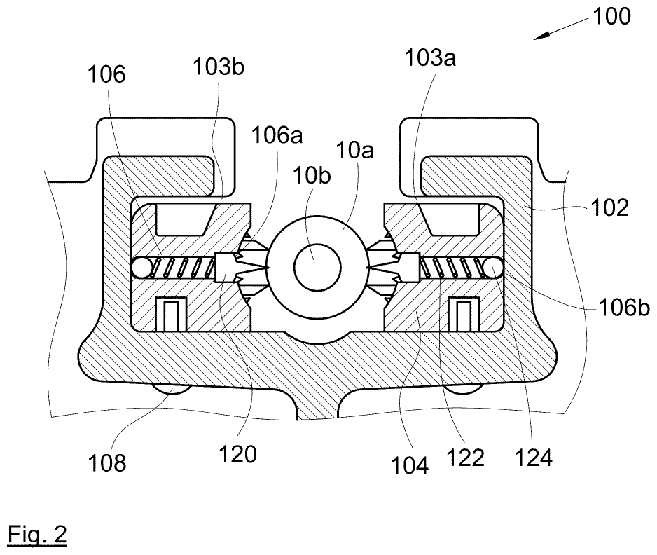

For at least one jaw 104, said jaw 104 is pierced by a through-hole 106. Here, each jaw has a through-hole 106 and FIG. 2 is a cross section at the level of the through-holes 106. The through-hole 106 has a first opening 106 and a second opening 106 b. The first opening 106 opens in the channel 104a and the second opening 106b faces a wall of the body 102, preferentially in front of the bottom of the corresponding groove 103a-b.

For at least one through-hole 106, here the two, a sharp pin 120, a spring 122 and a ball 124 are introduced in said through-hole 106. The sharp pin 120, the spring 122 and the ball 124 are made of an electrically conductive material, for example metal.

The sharp pin 120 is fixed at the first opening 106a of the through-hole 106 so that a sharp end of the sharp pin 120 emerges in the corresponding channel 104a. For example, the sharp pin 120 is glued in the first opening 106a of the through-hole 106.

The ball 124 is arranged at the second opening 106b of the through-hole 106 and the spring 122 is arranged between the sharp pin 120 and the ball 124.

The length of the spring 122 is sufficient to ensure that the spring 122 is in contact with both, the sharp pin 120 and the ball 124. With this arrangement the spring 122, the sharp pin 120 and the ball 124 are in electrical contact.

At the same time, the spring 122 is such that the ball 124 is in contact with the body 102 through the second opening 106b of the through-hole 106. It means that the sharp pin 120 and the body 102 are in electrical contact.

When the jaws 104 are translated in the body 102, they are getting closer and the sharp end of the sharp pin 120 penetrates in the insulating sheath 10a and comes into contact with the conductor 10b. It means that the contact of the conductor 10b with the sharp pin 120 and the body 102 is done at the same time as the jaws 104 are set into position.

To allow the contact of the ball 124 with the body 102 and to avoid that the ball 124 escapes from the second opening 106b of the through-hole 106, the diameter of the through-hole 106 at the second opening 106b is smaller than the diameter of the ball 124.

To stop the translation of the jaws 104 when they are installed, for each jaw 104, the dead end clamp 100 comprises blocking means 108 arranged to block the translation of said jaw 104 in relation to the body 102. Here, the blocking means 108 take the form of a screw which is fixed in a hole 108a of the body 102 and extends in recess 108 in the corresponding jaw 104.

In the embodiment represented in FIG. 1, each jaw 104 comprises at its distal end 105b, fastening means 110a-b which are arranged to cooperate with the fastening means 110b-a of the other jaw 104. These fastening means 110a-b attach the two distal end 105b together. The fastening means 110a-b avoid the separation of the jaws 104 but allow the rapprochement of the jaws 104 when they are inserted and translated in the body 102.

Here one of the fastening means 110a are elastic clips fixed to the corresponding jaw 104 and the other fastening means 110b are a slot realized in the corresponding jaw 104. The slot 110b receives the elastic clips 110a. The elastic clips 110a come into abutment behind the wall delimiting the slot 110b. The elastic clips 110a can translate in the slot 110b but are stopped by the wall delimiting the slot 110b.

To improve the holding of the cable 10 between the jaws 104, each channel 104a comprises additional teeth 112 arranged on the surface of the channel 104a. Here, the teeth 112 are fixed in appropriate housings 112a realized in the jaws 104.

1. A dead end clamp for the fixation of a cable, said dead end clamp comprising:
a body made of an electrically conductive material and comprising between a first end and a second end, two grooves facing each other and wherein a distance between bottoms of the grooves decreases between the first end and the second end,
an anchoring hook made of an electrically conductive material and fixed to the body,
for each groove, a jaw made of an electrically insulating material and mobile in translation in said groove from the first end toward the second end each jaw comprising a channel adapted to receive the cable,
for at least one jaw a through-hole crossing said jaw wherein a first opening of the through-hole opens in the channel and wherein a second opening of the through-hole faces the body, and
for each through-hole, a sharp pin a spring and a ball wherein the sharp pin, the spring and the ball are made of an electrically conductive material, wherein the sharp pin is fixed at the first opening of the through-hole so that a sharp end of the sharp pin emerges in the corresponding channel, wherein the ball is arranged at the second opening of the through-hole, wherein the spring is arranged between the sharp pin and the ball and wherein the length of the spring is sufficient to ensure that the spring is in contact with the sharp pin and the ball and that the ball is in contact with the body.

2. The dead end clamp of claim 1, wherein a diameter of the through-hole at the second opening is smaller than a diameter of the ball.

3. The dead end clamp of claim 1, wherein, for each jaw the dead end clamp comprises blocking means arranged to block the translation of said jaw

4. The dead end clamp of claim 1, wherein each jaw comprises a proximal end and a distal end, wherein the proximal end is introduced in the corresponding groove and wherein each jaw comprises at its distal end fastening means arranged to cooperate with the fastening means of the other jaw to attach the two distal ends together.

5. The dead end clamp of claim 4, wherein one of the fastening means are elastic clips fixed to the corresponding jaw and wherein the other fastening means are a slot realized in the corresponding jaw and arranged to receive said elastic clips.

6. The dead end clamp of claim 1, wherein each channel comprises teeth arranged on a surface of the channel.
